(19) United States
(12) Patent Application Publication
(10) Pub. No.: US 2012/0120190 A1
(43) Pub. Date: May 17, 2012

(54) DISPLAY DEVICE FOR USE IN A FRAME SEQUENTIAL 3D DISPLAY SYSTEM AND RELATED 3D DISPLAY SYSTEM

(76) Inventor: Hung-Chia Lee, Tainan County (TW)

(21) Appl. No.: 12/946,868

(22) Filed: Nov. 16, 2010

(51) Int. Cl. H04N 13/00

(52) U.S. Cl. 348/43; 348/E13.036

(57) ABSTRACT

A 3D display system includes an image source and a display device. The image source is configured to provide a 2D video signal consisting of multiple side-by-side frames for representing an image and generate an upsampled 2D video signal by increasing the frame rate of the source 2D video signal. The display device includes an identical frame detector and a 2D/3D converter. After identify corresponding pairs of side-by-side frames in the upsampled 2D video signal, the identical frame detector instructs the 2D/3D converter to extract a predetermined half of each side-by-side frame in the upsampled 2D video signal, and convert the extracted halves of the side-by-side frames alternatively into a series of right-eye images and a series of left-eye images constituting a 3D video signal.

### BACKGROUND OF THE INVENTION

1. Field of the Invention

The present invention is related to a display device for use in a 3D display system and a related 3D display system, and more particularly, to a display device for use in a frame sequential 3D display system and a related frame sequential 3D display system which performs 2D/3D conversion without using a frame buffer.

2. Description of the Prior Art

Three-dimensional (3D) display technology provides more vivid visual experiences than traditional two-dimensional (2D) display technology. In general, the stereoscopic image processing involves two camera systems in which two different images or videos are taken from slightly different camera angles and locations. Techniques to artificially create a perception of depth on a 2D surface include the use of presenting different images to the left and right eyes of the viewer. In such frame sequential 3D display system, a sequence of alternating frames wherein each successive frame carries the image meant for one or the other eye is presented to each eye using shutter glasses having a left-eye lens and a right-eye lens, each of which may be made from electronically controllable liquid crystal assemblies. The lenses are configured to be alternatively switched on and off in sync with the alternating frames such that the right eye only views the right-eye images and the left eye only views the left-eye images. The two series of images are combined by the brain in such a way to perceive depth.

Most recently released 3D high-definition televisions (HDTVs) operate according to the frame sequential 3D display method described above. However, this doesn't mean that the input signal to the 3D HDTV has to be in a frame-sequential format. Instead, many 3D HDTVs can process signals in a variety of different formats and perform on-the-fly conversion of the incoming video signal into a frame sequential format. While frame-sequential 3D is part of the blu-ray 3D specification, the video data in a side-by-side format is often preferred when it comes to airing 3D content over cable/air.

FIG. 1 is a diagram illustrating a method of creating a 1280×720 full resolution side-by-side frame SBS from an original left-eye frame L and an original right-eye frame R of the same full resolution. The side-by-side frame SBS consists of two halves on the left and right, with the entire left-eye frame L scaled down horizontally to fit the left-half of the side-by-side frame, and the entire right-eye frame R scaled down horizontally to fit the right-half of the side-by-side frame. Thus, the side-by-side frame SBS consists of the horizontally down-scaled left-eye frame L′ with a resolution of 640×720 and adjacent to it, the corresponding horizontally down-scaled right-eye frame R′ with the same 640×720 resolution.

Many display devices, such as televisions, have a scan rate of 60 Hz (ex. in the United States) or 50 Hz (in some countries other than the United States). In regular 2D mode, a frame sequential television displays a new image fifty or sixty times per second in order to present a dynamic video presentation to the viewer. In 3D mode, the effective refresh rate of the frame sequential television is halved since each eye needs a separate picture. Therefore, for a 3D display device capable of receiving and converting a source 2D video signal in side-by-side format, the frame rate of the 50/60 Hz source 2D video signal needs to be doubled for generating a corresponding 100/120 Hz upsampled 2D video signal, based on which each half of the side-by-side frames may be sequentially extracted and processed for obtaining corresponding full resolution right-eye and left-eye images constituting a corresponding 100/120 Hz 3D video signal.

FIG. 2 is a functional diagram illustrating a prior art frame sequential 3D display system 100. The frame sequential 3D display system 100 includes an image source 110, a 3D display device 120, and shutter glasses 140. The image source 110 may provides a source 2D video signal S1 consisting of multiple side-by-side frames representing an image. The 3D display device 120 is a frame sequential display which includes a frame rate converter 12, a frame buffer 14, a 2D/3D converter 16, a shutter controller 18, and a screen 20.

The 3D display device 120 may convert the source 2D video signal S1 consisting of side-by-side frames into a corresponding 3D video signal S3 consisting of left-eye and right-eye sequential frames. The frame rate converter 12 is configured to increase the total number of side-by-side frames in the source 2D video signal S1 by inserting new side-by-side frames between two neighboring side-by-side frames of the original source 2D video signal S1, thereby generating a corresponding upsampled 2D video signal S2 with a higher frame rate. The 2D/3D converter 26 may then split each side-by-side frame of the upsampled 2D video signal S2 for extracting two series of down-scaled frames, based on which the 3D video signal S3 may be generated. The 3D video signal S3 consists of two series of alternating sequential frames, one of which corresponds to left-eye images and the other of which corresponds to right-eye images. According to the 3D video signal S3, the frame sequential display device 130 may display the right-eye and left eye images in an alternative manner and control the lenses of the shutter glasses 140 accordingly so that each eye only views the images intended for that eye.

FIG. 3 is a diagram illustrating the operation of the prior art 3D display device 120. Assume that the source 2D video signal S1 includes data represented by a sequence of side-by-side frames SBS₁-SBS_{N} each consisting of a down-scaled left-eye frame and a corresponding down-scaled right-eye frame. The down-scaled left-eye frames and the down-scaled right-eye frames constituting corresponding side-by-side frames SBS₁-SBS_{N} are represented by L₁′-L_{N}′ and R₁′-R_{N}′, respectively. The frame buffer 14 is used to store the side-by-side frames SBS₁-SBS_{N} received during corresponding periods. Therefore, the frame rate converter 22 may output each of the side-by-side frames SBS₁-SBS_{N} for two consecutive times so as to generate the corresponding upsampled 2D video signal S2 having twice the number of side-by-side frames (SBS₁-SBS_{N} and SBS₁′-SBS_{N}′) compared to those in the original source 2D video signal S1. According to each pair of side-by-side frames in the upsampled 2D video signal S2, the 2D/3D converter 16 may extract a corresponding one of the down-scaled left-eye frames L₁′-L_{N}′ and a corresponding one of the down-scaled right-eye frame R₁′-R_{N}′, in a sequence of L₁′, R₁′, L₂′, R₂′, . . . , L_{N}′ and R_{N}′. Using up-scaling algorithms, the down-scaled left-eye frames L₁′-L_{N}′ and the down-scaled right-eye frames R₁′-R_{N} may then be respectively re-scaled to full resolution left-eye frames L₁-L_{N} and right-eye frame R₁-R_{N} which constitute the 3D video signal S3. The 3D display device 100 may then display the left-eye frames L₁-L_{N} and right-eye frame R₁-R_{N} alternatively in a frame-sequential manner which is in sync with the shutter glasses 140 whose operation may be illustrated by a left-eye ON signal and a right-eye ON signal in FIG. 3.

In the prior art 3D display device 120, the frame buffer 14 is required to store each side-by-side frame over a period of time for doubling each side-by-side frame. Therefore, there is a need for a 3D display device capable of performing 2D/3D conversion without using a frame buffer.

### SUMMARY OF THE INVENTION

The present invention provides a frame sequential 3D display system including an image source and a display device. The image source is configured to provide a source 3D video signal having a plurality of side-by-side frames each consisting of a corresponding pair of horizontally down-scaled right-eye and left-eye frames for representing an image and generate an upsampled 2D video signal by outputting each side-by-side frame of the source 2D video signal for two consecutive times. The display device includes a 2D/3D converter configured to receive the upsampled 2D video signal, extract a predetermined half of each side-by-side frame in the upsampled 2D video signal, and convert the extracted halves of the side-by-side frames alternatively into a series of right-eye images and a series of left-eye images constituting a 3D video signal; and a screen for alternatively displaying the series of right-eye images and the series of left-eye images according to the 3D video signal.

The present invention also provides a display device for use in a frame sequential 3D display system and including a 2D/3D converter and a screen. The 2D/3D converter is configured to receive an upsampled 2D video signal directly from an image source, extract a predetermined half of each side-by-side frame in the upsampled 2D video signal, and convert the extracted halves of the side-by-side frames alternatively into a series of right-eye images and a series of left-eye images constituting a 3D video signal, wherein a frame rate of the upsampled 2D video signal is equal to a frame rate of the 3D video signal. The screen alternatively displays the series of right-eye images and the series of left-eye images according to the 3D video signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a method of creating a full resolution side-by-side frame.

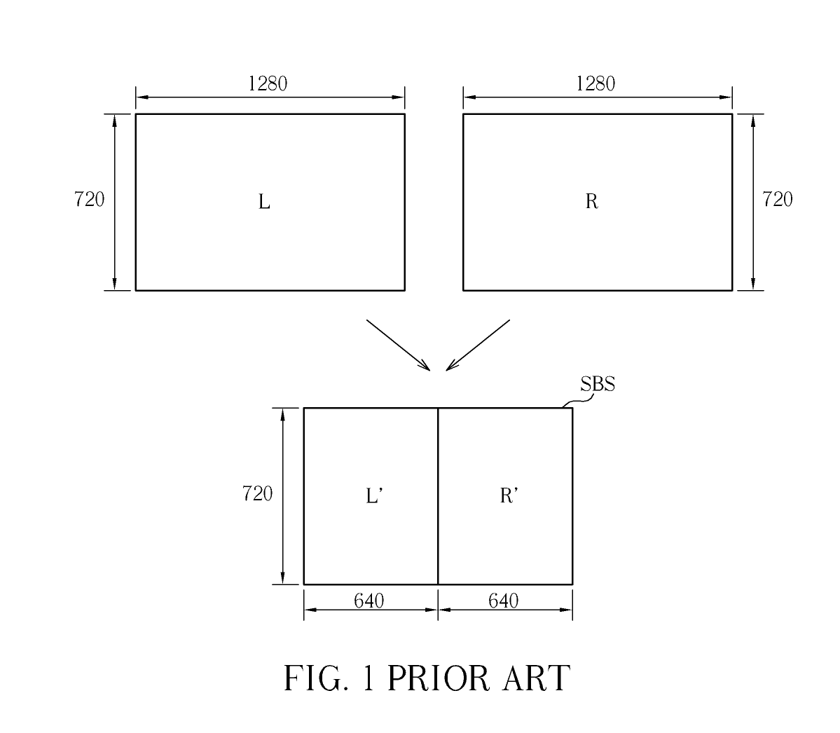

FIG. 2 is a functional diagram illustrating a prior art frame sequential 3D display system.

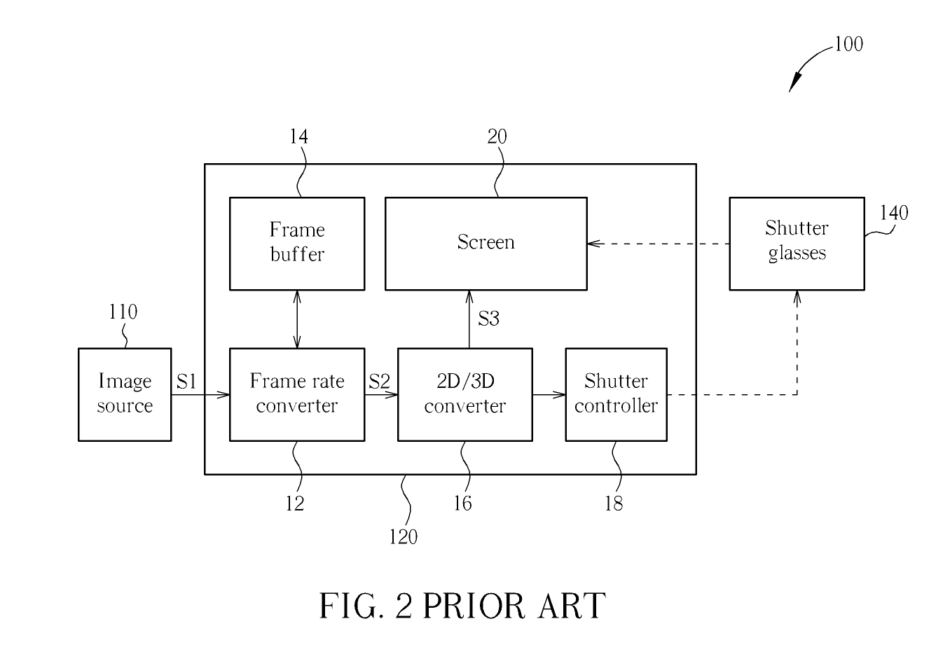

FIG. 3 is a diagram illustrating the operation of a prior art frame sequential 3D display device.

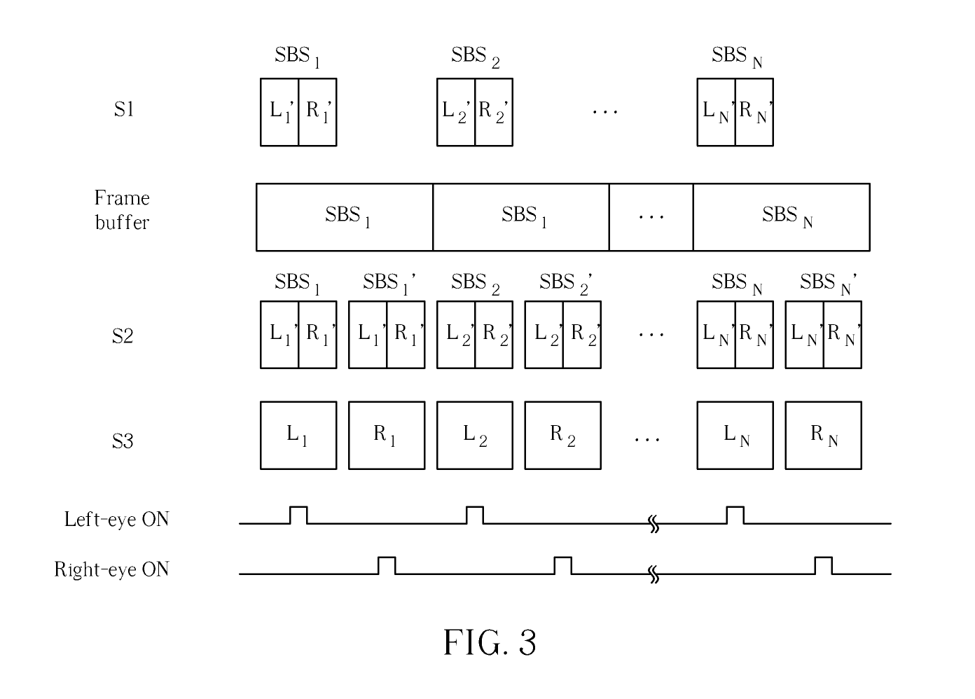

FIG. 4 is a functional diagram illustrating a frame sequential 3D display system according to a first embodiment of the present invention.

FIG. 5 is a diagram illustrating the operation of a frame sequential 3D display system according to the present invention.

FIG. 6 is a functional diagram illustrating a frame sequential 3D display system according to a second embodiment of the present invention.

FIG. 7 is a diagram illustrating the operation of a display device according to the present invention.

### DETAILED DESCRIPTION

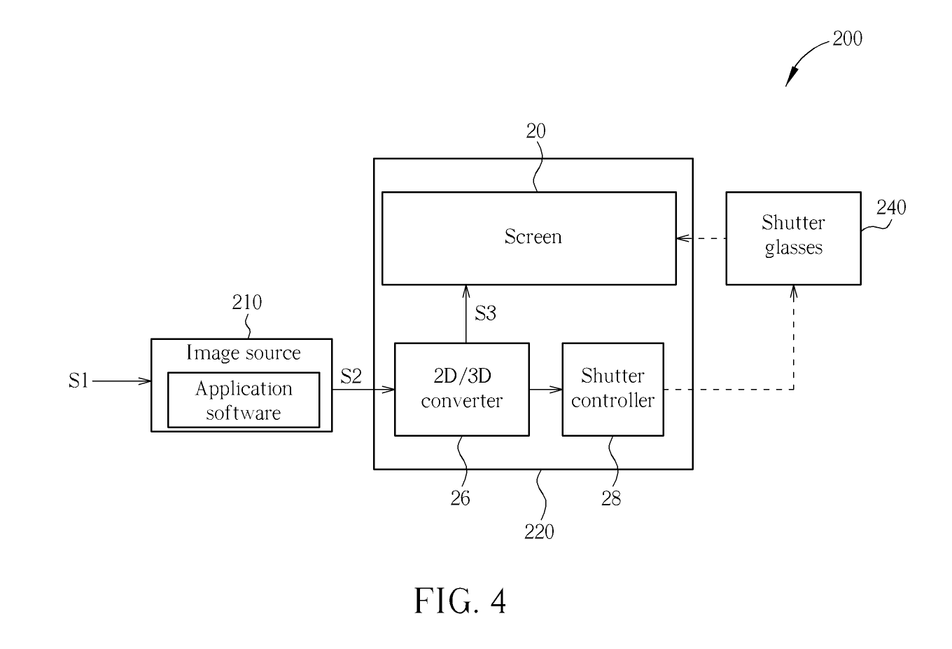

FIG. 4 is a functional diagram illustrating a frame sequential 3D display system 200 according to a first embodiment of the present invention. The frame sequential 3D display system 200 includes an image source 210, a 3D display device 220, and shutter glasses 240. The image source 210 may include any electronic appliances installed with application software (such as Media Player) which may display images in various modes. Therefore, according to a source 2D video signal S1 consisting of side-by-side frames representing an image, the image source 210 may generate a corresponding upsampled 2D video signal S2 by playing back each of the side-by-side frame in the source 2D video signal S1 for two consecutive times.

The 3D display device 220 is a frame sequential display which includes a 2D/3D converter 26, a shutter controller 28 and a screen 20. The 3D display device 220 is configured to convert the upsampled 2D video signal S2 consisting of side-by-side frames into a corresponding 3D video signal S3 consisting of sequential frames which alternatively correspond to left-eye images and right-eye images. The left-eye and right-eye images may then be displayed on the screen 20 alternatively in a frame sequential manner for viewing with the shutter glasses 240 in order to create stereoscopic effects.

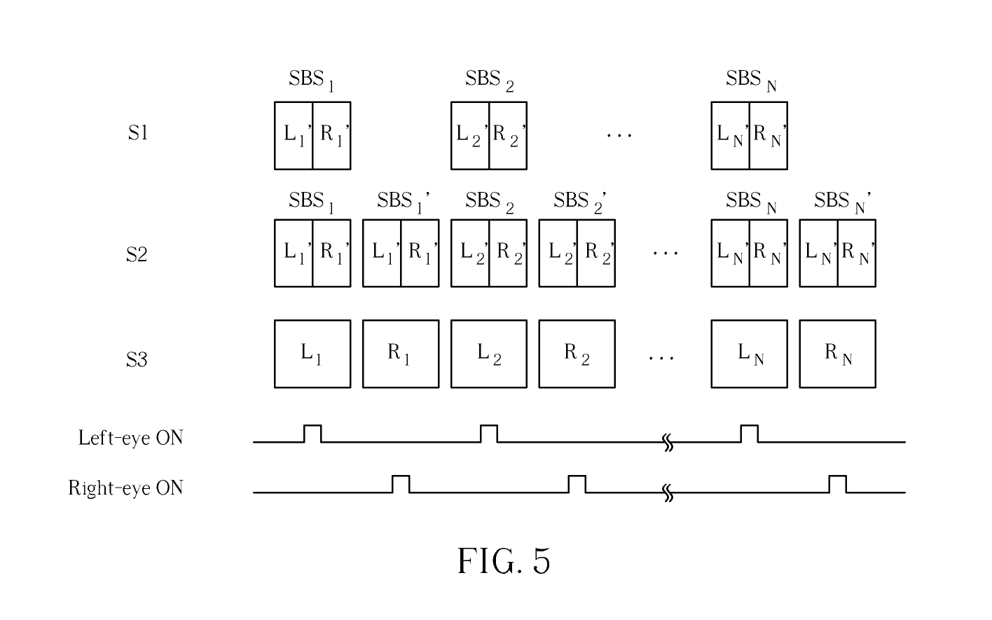

FIG. 5 is a diagram illustrating the operation of the 3D display device 220 according to the present invention. Assume that the source 2D video signal S1 includes data represented by a sequence of side-by-side frames SBS₁-SBS_{N} each consisting of a down-scaled left-eye frame and a corresponding down-scaled right-eye frame. The down-scaled left-eye frames and the down-scaled right-eye frames constituting corresponding side-by-side frames SBS₁-SBS_{N} are represented by L₁′-L_{N}′ and R₁′-R_{N}′, respectively. In the frame sequential 3D display system 200 of the present invention, the image source 210 is configured to provide the upsampled 2D video signal S2 which has twice the number of side-by-side frames compared to those in the original source 2D video signal S1. As depicted in FIG. 5, the upsampled 2D video signal S2 inputted to the 3D display device 220 consists of pairs of side-by-side frames SBS₁-SBS₁′, SBS₂-SBS₂′, . . . , and SBS_{N}-SBS_{N}′. According to each pair of side-by-side frames in the upsampled 2D video signal S2, the 2D/3D converter 26 may extract a corresponding one of the down-scaled left-eye frames L₁′-L_{N}′ and a corresponding one of the down-scaled right-eye frame R₁′-R_{N}′, in a sequence of L₁′, R₁′, L₂′, R₂′, . . . , L_{N}′ and R_{N}′. Using up-scaling algorithms, the down-scaled left-eye frames L₁′-L_{N}′ and the down-scaled right-eye frames R₁′-R_{N}′ may then be respectively re-scaled to full resolution left-eye images L₁-L_{N} and right-eye images R₁-R_{N} which constitute the 3D video signal S3. The 3D display device 220 may then display the left-eye images L₁-L_{N} and right-eye images R₁-R_{N} alternatively in a frame-sequential manner which is in sync with the shutter glasses 240 whose operation may be illustrated by a left-eye ON signal and a right-eye ON signal in FIG. 5.

In the frame sequential 3D display system 220, the 3D display device 220 directly receives the upsampled video signal S2 provided by the image source 210 and may perform direct 2D/3D conversion without using a frame buffer.

As illustrated, up-sampling is performed by the image source 210 and 2D/3D format conversion is performed by the 3D display device 220 in the present invention. Regarding two consecutive side-by-side frames in the upsampled 2D video signal S2, they may be two identical side-by-side frames based on which a corresponding pair of left-eye and right-eye images may be generated (such as the two consecutive side-by-side frames SBS₁ and SBS₁′ based on which the corresponding images L₁ and R₁ are generated), or two side-by-side frames based on which a left-eye image in a certain pair of left-eye and right-eye images and a right-eye image in another pair of left-eye and right-eye images may be generated (such as the two consecutive side-by-side frames SBS₁′ and SBS₂ based on which the images R₁ and L₂ are generated). Therefore, there is a need to identify the relationship between two consecutive side-by-side frames in the upsampled 2D video signal S2 in order to guarantee the synchronization between the operation of the shutter glasses 240 and the 3D video signal S3.

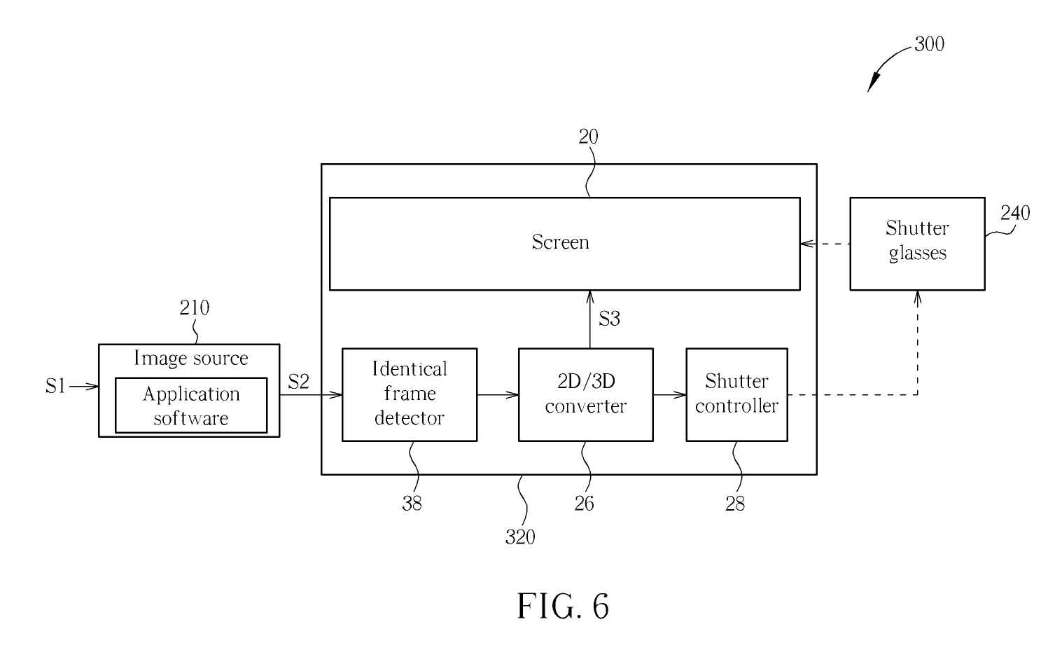

FIG. 6 is a functional diagram illustrating a frame sequential 3D display system 300 according to a second embodiment of the present invention. The frame sequential 3D display system 300 includes an image source 210, a 3D display device 320, and shutter glasses 240. Similar to the frame sequential 3D display system 200 according to the first embodiment of the present invention, the 3D display device 320 of the frame sequential 3D display system 300 further includes an identical frame detector 38. The identical frame detector 38 is configured to analyze the image characteristics of the side-by-side frames SBS₁-SBS_{N} and SBS₁′-SBS_{N}′ for a predetermined period of time, thereby identifying the corresponding frame pairs in the upsampled 2D video signal S2. Next, the identical frame detector 38 may instruct the 2D/3D converter 26 to begin format conversion and the shutter control 28 may operate the lenses of the shutter glasses 240 in sync with respective left-eye and right-eye images.

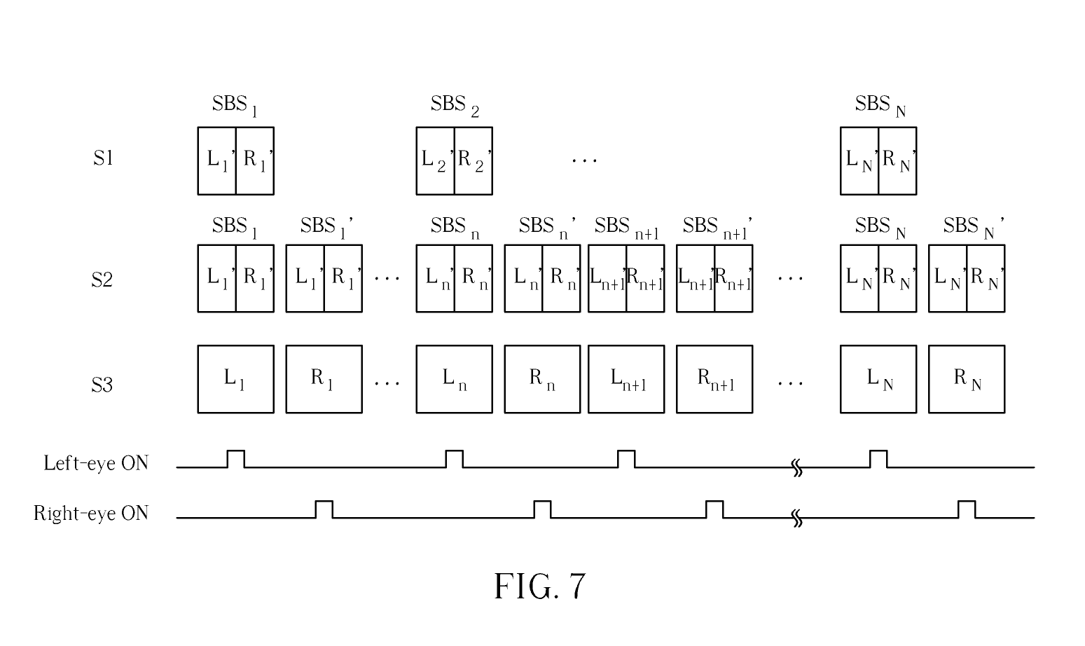

FIG. 7 is a diagram illustrating the operation of the 3D display device 320 according to the present invention. The identical frame detector 38 may perform image analysis on the upsampled 2D video signal S2 for a predetermined period of time, such as on the first n frame pairs SBS₁, SBS₁¹, SBS₂, SBS₂′, . . . , SBSₙ, SBSₙ′ (n is an integer smaller than N) for identifying the corresponding frame pairs based on checksum or histogram of the side-by-side frames, or based on other image characteristics well-known to those skilled in the art. For any three consecutive side-by-side frames such as SBS₁, SBS₁′, and SBS₂ in the upsampled 2D video signal S2, the image characteristic of the side-by-side frame SBS₁′ is identical to that of the side-by-side frame SBS₁ but differs from that of the side-by-side frame SBS₂ since the side-by-side frames SBS₁ and SBS₁′ are replicas. Therefore, if two consecutive side-by-side frames in the upsampled 2D video signal S2 have identical image characteristics, they may be identified as a corresponding frame pair. Next, the 2D/3D converter 26 may thus perform 2D/3D conversion on the side-by-side frames SBSₙ₊₁-SBS_{N}′ and the shutter control 28 may switch on/off the lenses of the shutter glasses 240 in an alternative fashion when respective left-eye and right-eye images are outputted, as depicted by a left-eye ON signal and a right-eye ON signal in FIG. 7.

In one embodiment of FIG. 7, only three consecutive side-by-side frames such as SBS₁, SBS₁′, and SBS₂ in the upsampled 2D video signal S2 are required for identifying the corresponding frame pairs. In another embodiment of FIG. 7, more consecutive side-by-side frames such as SBS₁, SBS₁′, SBS₂, SBS₂′, . . . , SBSₙ, SBSₙ′ in the upsampled 2D video signal S2 may be used for identifying the corresponding frame pairs so as to achieve better accuracy.

The present invention may be applied to a glass-type frame sequential 3D display system which requires shutter glasses for creating stereoscopic effect, as depicted in FIGS. 4-7. However, the present invention may also be applied to other types of frame sequential 3D display system, such as a naked-eye directional backlight time sequential 3D display system or a time-multiplexed polarizer 3D projector.

In the frame sequential 3D display system of the present invention, up-sampling is performed by the image source. The 3D display device may thus perform 2D/3D conversion directly according to the upsampled signal received from the image source without using a frame buffer.

Those skilled in the art will readily observe that numerous modifications and alterations of the device and method may be made while retaining the teachings of the invention.

What is claimed is:

1. A frame sequential three-dimensional (3D) display system, comprising:
an image source configured to provide a source two-dimensional (2D) video signal having a plurality of side-by-side frames each consisting of a corresponding pair of horizontally down-scaled right-eye and left-eye frames for representing an image and generate an upsampled 2D video signal by outputting each side-by-side frame of the source 2D video signal for two consecutive times;
a display device comprising:
a 2D/3D converter configured to receive the upsampled 2D video signal, extract a predetermined half of each side-by-side frame in the upsampled 2D video signal, and convert the extracted halves of the side-by-side frames alternatively into a series of right-eye images and a series of left-eye images constituting a 3D video signal; and
a screen for alternatively displaying the series of right-eye images and the series of left-eye images according to the 3D video signal.

2. The frame sequential 3D display system of claim 1, wherein the display device further comprises an identical frame detector configured to:
identify a corresponding pair of the side-by-side frames in the upsampled 2D video signal;
instruct the 2D/3D converter to extract a left-half of a first side-by-side frame in the corresponding pair of the side-by-side frames and a right-half of a second side-by-side frame in the corresponding pair of the side-by-side frames; and
instruct the 2D/3D converter to convert the extracted left-half of the first side-by-side frame into a corresponding left-eye image and convert the extracted right-half of the second side-by-side frame into a corresponding right-eye image.

3. The frame sequential 3D display system of claim 2, further comprising shutter glasses including an electronically controllable right-eye lens and an electronically controllable left-eye lens, wherein the right-eye lens is switched on and the left-eye lens is switched off when the corresponding right-eye image is displayed, and the left-eye lens is switched on and the right-eye lens is switched off when the corresponding left-eye image is displayed.

4. The frame sequential 3D display system of claim 2, wherein the identical frame detector is configured to identify the corresponding pair of the side-by-side frames in the upsampled 2D video signal by comparing image characteristics of three consecutive side-by-side frames in the upsampled 2D video signal.

5. The frame sequential 3D display system of claim 2, wherein the identical frame detector is configured to identify the corresponding pair of the side-by-side frames in the upsampled 2D video signal by comparing image characteristics of n consecutive side-by-side frames in the upsampled 2D video signal, wherein n is an integer larger than 3.

6. A display device for use in a frame sequential 3D display system, comprising:
a 2D/3D converter configured to receive an upsampled 2D video signal directly from an image source, extract a predetermined half of each side-by-side frame in the upsampled 2D video signal, and convert the extracted halves of the side-by-side frames alternatively into a series of right-eye images and a series of left-eye images constituting a 3D video signal, wherein a frame rate of the upsampled 2D video signal is equal to a frame rate of the 3D video signal; and
a screen for alternatively displaying the series of right-eye images and the series of left-eye images according to the 3D video signal.

7. The display device of claim 6 further comprising an identical frame detector configured to:
identify a corresponding pair of side-by-side frames in the upsampled 2D video signal;
instruct the 2D/3D converter to extract a left-half of a first side-by-side frame in the corresponding pair of the side-by-side frames and a right-half of a second side-by-side frame in the corresponding pair of side-by-side frames; and
instruct the 2D/3D converter to convert the extracted left-half of the first side-by-side frame into a corresponding left-eye image and convert the extracted right-half of the second side-by-side frame into a corresponding right-eye image.

8. The display device of claim 7 further comprising:
a shutter control configured to switch on a right-eye lens of shutter glasses and switch off a left-eye lens of the shutter glasses when the corresponding right-eye image is displayed, and configured to switch off the right-eye lens and switch on the left-eye lens when the corresponding left-eye image is displayed.

9. The display device of claim 7, wherein the identical frame detector is configured to identify the corresponding pair of the side-by-side frames in the upsampled 2D video signal by comparing image characteristics of three consecutive side-by-side frames in the upsampled 2D video signal.

10. The display device of claim 7, wherein the identical frame detector is configured to identify the corresponding pair of the side-by-side frames in the upsampled 2D video signal by comparing image characteristics of n consecutive side-by-side frames in the upsampled 2D video signal, wherein n is an integer larger than 3.
